(19) United States
(12) Patent Application Publication
(10) Pub. No.: US 2005/0077640 A1
(43) Pub. Date: Apr. 14, 2005

(54) Process for manufacturing a mixture based on a plastic

(75) Inventors: Eric Fassiau, Brussels (BE); Jean-Philippe Dumont, Brussels (BE); Luca Lussetich, Ferrare (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY SA, Brussels (BE)

(21) Appl. No.: 10/502,776

(22) PCT Filed: Jan. 22, 2003
(86) PCT No.: PCT/EP03/00697

(30) Foreign Application Priority Data
Jan. 31, 2002 (FR) 0201181

(51) Int. Cl. B29B 9/00

(52) U.S. Cl. 264/5

(57) ABSTRACT

Process for manufacturing a mixture based on a plastic and on at least one additive, according to which: 1. the plastic in the form of powder or of pellets is dissolved in a solvent; 2. the additive(s) is/are introduced into the solution after or during the dissolution; 3. the precipitation of the plastic in solution is brought about by injecting a non-solvent.

The present invention relates to a process for the manufacture of a mixture based on a plastic, and to mixtures obtainable by this process.

Plastics are widely used for the manufacture of various flexible or rigid products, such as tarpaulins, coated textiles and other components for vehicle interior trim, pipes, window frames or electrical cables with polymeric insulation.

The plastics are therefore generally used in the form of a mixture with various additives such as stabilizers, plasticizers, pigments, etc. The term used in the art for these mixtures is “compounds” and the manufacturing operation for these mixtures is generally termed “compounding”.

When the plastic is in the form of a powder, compounding can take place via simple physical mixing of this powder with the additive(s), as long as these latter are also pulverulent or liquid. In some cases, the mixture obtained is then pelletized by passage through an extruder. If the plastic and/or additives are not pulverulent (or liquid in the case of the additives), the mixing generally takes place via gelling and/or melting in an extruder, the mixture being pelletized at the extruder outlet.

Compounding processes of this type have numerous disadvantages:
they require good dispersibility of the additives within the matrix of plastic; some types of pigments and of plasticizers cannot therefore be dispersed homogeneously by these techniques
the cleaning of the compounding equipment is often laborious
in the case of the manufacture of masterbatches (concentrates with pigments or other additives, intended to be diluted with the virgin plastic during final processing), the resin used as binder for the additive is often a special grade, which can interfere with the processing of the resin used for the final application
the use of mechanical stresses during the manufacture of the mixtures can degrade the mixtures.

In the case of resins in the form of a latex (i.e. a dispersion of particles in a liquid, for example after emulsion polymerization), it has been proposed that some of these disadvantages can be eliminated by carrying out the compounding operation prior to coagulation of the latex. For example, EP 0 202 012 describes a compounding process according to which the resin and the additives are separately dispersed in an aqueous medium, the two resultant latices are mixed, and the entire material is coagulated. Of course, a process of this type is applicable only to latices and/or to plastics and additives which are dispersible in an aqueous medium. Furthermore, it is successful only with latices of similar stability, therefore requiring specific adjustments and measures in that regard.

In contrast, the present invention provides a simple process which is applicable to resins in traditional commercial form (powder or pellets), which permits admixture of low-dispersibility additives, and which gives a finely-divided compound with consistent particle sizes particularly well suited to certain applications.

The present invention therefore provides a process for manufacturing a mixture based on a plastic and on at least one additive, according to which:
1. the plastic in the form of powder or of pellets is dissolved in a solvent;
2. the additive(s) is/are introduced into the solution after or during the dissolution;
3. the precipitation of the plastic in solution is brought about by injecting a non-solvent

The plastic used in the process according to the present invention is a traditional commercial resin in the form of powder or of pellets, i.e. in the form of particles suitable for processing. It may be a virgin resin which has never undergone processing in the melt Alternatively, it may be a used resin coming from a suitable recycling process providing particles suitable for use. The powder used in the present invention may therefore, for example, be a “crude” powder from polymerization, i.e. a pulverulent plastic which is the direct result of a suspension polymerization or emulsion polymerization reaction. Alternatively, the powder used in the present invention may be a used resin powder, coming from a recycling process which has produced divided material, suitable for use. “Pellets” mean extruded strands of plastic (virgin or used) cut at the extruder outlet.

The plastic used in the process according to the present invention may be a non-polar plastic, such as a polymer of ethylene (PE) or of propylene (PP). It may also be a polar plastic such as a polymer of vinyl chloride (PVC) or of vinylidene chloride (PVDC). Good results have been obtained with PVC. PVC means any homo- or copolymer containing at least 50% by weight of vinyl chloride.

The solvent capable of dissolving the plastic is preferably chosen from liquids having a solubility parameter (a definition, and experimental values, for which is found in “Properties of Polymers”, D. W. Van Krevelen, 1990 Edition, pp. 200-202, and in “Polymer Handbook”, J. Brandrup and E. H. Immergut, Editors, Second Edition, p. IV-337 to IV-359) close to the solubility parameter of the plastic to be dissolved. The non-solvent for the plastic is preferably chosen so as to have a solubility parameter greatly different from that of the plastic material to be dissolved. Of course, solvent and non-solvent mean either pure substances or mixtures of substances.

The dissolution generally takes place under a pressure which is at least atmospheric pressure, more specifically at least 1.5 bar. This pressure advantageously does not exceed 10 bar, preferably 5 bar.

The dissolution temperature is generally at least 75° C., more specifically 100° C.; it generally does not exceed 125° C., more specifically 110° C.

It can moreover prove advantageous to operate in an inert atmosphere, for example under nitrogen, to avoid any risk of explosion or of degradation of the solvent and/or of the non-solvent.

The dissolution of the plastic in the solvent takes place in a vessel or dissolution tank generally equipped with a suitable device for controlling temperature and pressure.

After or during the dissolution of the plastic, but before its precipitation, the additive(s) is/are added to the solution present in the dissolution tank. According to the present invention, “additive” means any organic or inorganic chemical compound not present in the original plastic or present in an amount below that desired. Inorganic additives which may be mentioned are inorganic pigments, carbon black, metal powders, various types of nanoparticles. Organic additives which may be mentioned are organic pigments, stabilizers, oligomers. The present invention is particularly well suited to the incorporation of non-polymeric organic and/or inorganic additives.

The additives according to the present invention may be liquids or solids. These additives may be soluble or insoluble in the solution but it is preferable to obtain a homogeneous dispersion or solution by suitable means and mainly by suitable stirring. This may be provided by any known device, e.g. by a mechanical stirrer, by insufflation of a gas, etc. The method of dissolution and/or fine suspension in the solvent and the precipitation conditions are adapted for each case so as to ensure the homogeneity of the final product

The additive content of the compound (or polymer-based mixture) obtained by precipitation particularly depends on the nature of this additive. For example, in the case of solid additives and particularly those such as carbon black and pigments, this content is generally between 0.1 and 95% (by weight based on the total weight of the polymer compound+additive), more specifically between 0.5 and 75%. If this additive is a plasticizer, its content is generally between 1 and 95%, more specifically between 10 and 80% (by weight based on the total weight of the polymer compound+additive).

If the additive is a pigment, to optimize the colour strength it is essential to control the incorporation and the dispersion of the pigment in the solvent and to ensure the stability of the said dispersion over time. Surprisingly, the applicant has found that in the process according to the invention the dispersion given by certain pigments (and in particular organic pigments) is ideal and stable over time although this type of additive is known to have a tendency to flocculate in a solvent medium. The process according to the present invention therefore permits the manufacture of very high-quality concentrated pigment dispersions.

Once the plastic has been dissolved and the additives are present in the solution, the dissolved plastic and the additive are precipitated by adding, to the dissolution tank, an amount of the non-solvent sufficient to bring about the complete precipitation of the dissolved plastic. This precipitation is advantageously carried out by injecting non-solvent in both liquid and gaseous form (i.e. the liquid phase and the gaseous phase are injected at the same time, being injected simultaneously or in a sequence) thus accelerating the precipitation of the plastic. The non-solvent injected may, without adverse effect, comprise a low concentration of solvent; this is of interest to the extent that, as explained below, a possible subsequent step of the process may specifically provide a relevant source of non-solvent, which may therefore be reused without specific purification.

In the process according to the present invention, the plastic precipitated is separated from the solvent/non-solvent mixture by any known means (evaporation, centrifugation, filtration, etc.).

In the context of the process according to the invention it is advantageous for the solvent used to be miscible with the non-solvent (at least in certain proportions, and this does not exclude the formation of two-phase mixtures in other proportions) and to form an azeotropic mixture with the non-solvent. In that case, much of the solvent may be removed by evaporation of the precipitation medium in the form of vapour of azeotropic composition. The solvent is advantageously chosen from methyl ethyl ketone (MEK), methyl isobutyl ketone and tetrahydrofuran. The non-solvent is advantageously water. It is preferable to utilize the combination MEK/water, which forms an azeotrope comprising (at atmospheric pressure) 11% of water and 89% of MEK (by weight). The combination MEK/water is moreover particularly well suited when the plastic is PVC.

According to one advantageous version of the process according to the present invention, a phase-separator compatible with the solvent and incompatible with the non-solvent is also present during the dissolution of the plastic in the solvent and promotes the same. The reason for this is that, given the cost of the reactants and the disadvantages which could arise through their disposal in the environment, it is desirable to treat the solvent/non-solvent mixture so that each of its constituents can be recovered separately. The addition of certain phase-separators to the solvent/non-solvent mixture can facilitate separation of this mixture and also increase the capability of the solvent-rich phase to dissolve the plastic in question. The process therefore becomes more flexible, less energy-intensive and less expensive.

According to this version of the invention, the phase-separator is defined as a chemical compound which promotes the separation of the mixtures of solvent/non-solvent for the plastic. According to this version of the present invention, the phase-separator is moreover compatible with the solvent and incompatible with the non-solvent. It will therefore be substantially absent from the non-solvent-rich phase coming from the separation of the mixture of the three chemical compounds, and this can be advantageous if the non-solvent can be disposed of into the environment (for example if the non-solvent is water), and also makes it easier to obtain a plastic substantially free from this agent The phase-separator preferably has a solubility parameter different from that of the plastic to be dissolved.

According to one particularly preferred version of the process according to the invention, the solubility parameter of the solvent is similar to that of the plastic and that of the phase-separator is:
lower than the solubility parameter of the plastic if the solubility parameter of the non-solvent is higher than that of the plastic,
higher than the solubility parameter of the plastic if the solubility parameter of the non-solvent is lower than that of the plastic.

The amount of solvent (or of mixture of solvent/phase-separator) to be used must be chosen so as to prevent the viscosity increase brought about by dissolving the plastic from interfering with the good conduct of the process (filtration, etc.). In some cases (and in particular in the absence of dispersing agents such as those described below and/or in the presence of plasticizers) it is preferable that during the dissolution step the amount of plastic does not exceed 250 g per litre of solvent and of any phase-separator, and in particular 200 g/l, preferably 100 g/l. In other cases (and particularly in the presence of suitable dispersing agents and/or in the absence of plasticizers) this content may be 250 g/l or more, more specifically 350 g/l or more.

When the process according to the invention is applied to the compounding of PVC, the solvent preferably chosen is MEK (methyl ethyl ketone), the non-solvent preferably chosen is water, and the phase-separator preferably chosen is an aliphatic hydrocarbon having from 5 to 7 carbon atoms. Excellent results have been obtained by choosing n-hexane as phase-separator.

In order to reduce the size of the particles obtained by precipitation, it is advantageous for this precipitation to take place in the presence of a dispersing agent. In practice, this is advantageously added to the solvent during the dissolution of the plastic, and preferably from its commencement. Alternatively, this dispersing agent may be added simultaneously with the non-solvent used for precipitation (either in the same stream or separately), but this procedure is more difficult to control and can lead to less homogenization of the medium. According to this version of the invention, the dispersing agent is surfactants, such as bentonite, polyvinyl alcohol, gelatine, cellulosic ethers or esters, water-soluble (co)polymers, etc. The cellulosic ethers and polyvinyl alcohols give good results. According to this version of the invention, the amount used of the dispersing agent is generally 0.001% by weight or more, based on the weight of the plastic, preferably 0.01% or more, or preferably 0.1% or more. The content of dispersing agent is generally 5% or less, more specifically 2% or less, or more preferably 1% or less.

Another means permitting reduction of the particle sizes of the product obtained is progressive addition of the non-solvent into the solvent comprising the dissolved plastic and progressive reduction of the pressure to below atmospheric pressure and during the addition of non-solvent. A phase inversion generally results here, i.e. the precipitation medium changes from a dispersion of the non-solvent in the solvent to a dispersion of the solvent in the non-solvent. This phenomenon is accompanied by a sharp fall in viscosity, from the moment when the plastic which was dissolved precipitates in the form of increasingly compact grains. It is particularly advantageous for the pressure reduction recommended above (and generally accompanied by a reduction in temperature) to take place prior to the phase inversion so that the inversion takes place at reduced pressure.

According to this advantageous version of the present invention, the pressure during the phase inversion is generally 0.9 bar or below, more specifically 0.8 bar or below, and preferably 0.7 bar or below. This pressure is generally 0.2 bar or above, more specifically 0.4 bar or above. Another advantage of reducing the pressure during the progressive addition of non-solvent is that this permits reduction of the threshold level of critical concentration of plastic above which the medium is observed to solidify. It may therefore be said to permit treating larger amount of plastic with the same amount of solvent.

Finally, for maximum reduction of particle sizes and to obtain a product free from agglomerate, it is advantageous both to use a dispersing agent and to reduce the pressure below atmospheric pressure during the progressive addition of non-solvent.

According to one preferred version of the process according to the invention, the phase-separator and the solvent are substantially removed from the precipitation medium by evaporation at a temperature below the boiling point of the non-solvent. This removal is in particular made possible by choosing substances whose boiling point is lower than that of the non-solvent and/or which give an azeotrope therewith.

In certain cases, the vapours comprising the solvent and the phase-separator also comprise a substantial fraction of non-solvent. These vapours therefore advantageously undergo condensation and separation and then removal of the non-solvent-rich phase, prior to reuse for dissolution of the plastic. This reuse may take place during a subsequent process, if the process of recycling the plastic is a discontinuous (or batch) process, or be an integral part of the process itself, if the process is continuous. The non-solvent-rich phase resulting from the separation may also be reused during the precipitation of the plastic, as mentioned above.

A significant advantage of the process according to the present invention is therefore that it can operate in a closed loop without generating waste, given that both the phase comprising the solvent and the phase-separator and that comprising the non-solvent can be recycled and reused in the process.

According to another advantageous version of the process according to the present invention, the vapours comprising the solvent and the phase-separator are simply condensed and reused as they stand for dissolution of the plastic, without prior separation. This is advantageous when these vapours comprise little non-solvent and/or when it is possible to work with a two-phase equilibrium involving two phases (one solvent-rich phase substantially comprising all of the phase-separator, since this is compatible with the solvent and incompatible with the non-solvent, and a non-solvent-rich phase). Correct choice of the concentrations of phase-separator (required to obtain a good solubility parameter) enables the solvent-rich phase to ensure selective dissolution of the plastic. The non-solvent-rich phase does not interfere with this dissolution. This is a significant cost saving in the process, since it saves a separation step which is often energy-intensive and therefore expensive.

It is often advantageous to choose a batch process which proceeds in a loop with recovery of the vapours comprising the solvent (and sometimes the phase-separator), and condensation, and recycling of a fraction of, or of the entirety of, these for dissolution in the following batch. Good results have been obtained here with MEK and solvent and n-hexane as phase-separator. The optimal phase-separator is added during the first batch, either at the dissolution step or after condensation of the vapours. The second approach has given good results. Prior to recycling (of a fraction) of the condensed vapours, it can be of interest to separate these, optionally using the phase-separator, and to remove the non-solvent-rich phase. Alternatively, it is possible to recycle the entirety of the condensed vapours, as long as a suitable amount of phase-separator is used. The reason for this is that the dissolution medium here comprises a significant amount of non-solvent, and the amount of phase-separator has to be sufficient to counterbalance the adverse effect of the non-solvent on the dissolution of the plastic material. With certain chemical compounds, such as MEK (as solvent), water (as non-solvent) and n-hexane (as phase-separator) the formation of two phases is observed during the dissolution. In this case, since the total water content of the medium is generally at least 5% (by weight), it is desirable to choose a hexane content which is also at least 5% (given that the remainder of the medium consists of MEK) in order to obtain an MEK-rich phase capable of dissolving the PVC over an acceptable range of temperatures. It is preferable for the water content not to exceed 15%, permitting the hexane content to be limited to 30%.

The process according to the present invention also permits the neutralization of certain impurities (catalyst residues, for example) in the plastic via treatment of the solution with a suitable reactant (e.g. with slaked lime in the case of PVC, permitting neutralization of ionizable species).

The process according to the present invention moreover has the advantage of providing a product with fine and regulated particle sizes. In the particular case of PVC, it can give fine rounded grains which can be used as they stand in certain applications, such as rotomoulding or slush moulding. The present invention therefore also provides a mixture based on a plastic and in particular on PVC, obtainable by the process described above and consisting of substantially spherical particles having an average diameter (d) of 800 μm less than, preferably less than 500 μm, more specifically less than 400 μm, but generally greater than 100 μm; more specifically 150 μm, with a distribution breadth such that at least 80% of the particles have a diameter between d−0.4d and 4+0.4d, more specifically between d−0.3d and d+0.3d. Surprisingly, it has moreover been found that in the case of PVC this product behaves like a pregelled product during processing, but without it being subjected to any heat-ageing (e.g. in consequence of passage through an extruder). It can therefore be used as it stands in applications starting from a powder (slush moulding, for example), and does not have to be converted to powder via a suitable method (micronization, for example), as is the case with pellets coming from traditional compounding (in an extruder).

In the light of the particularly high level of dispersion obtainable using the present invention, it is particularly well suited for the manufacture of pigment concentrates. For example, in the case of PVC it is possible to increase the content of pigments by a factor of more than two, based on the maximum content obtained by traditional compounding in an extruder, and this permits a significant reduction in the cost of formulations coloured by using smaller amounts of pigment concentrates. The process according to the invention can moreover give a very homogeneous pigment concentrate without subjecting the product and the pigments to heat-treatments often responsible for variation in the thermal stability of the final product and in its colour.

The present invention is also well suited to the manufacture of compounds for primary insulation, having improved dielectric performance characteristics. These are obtained because the dispersion of carbon black in the plastic is exceptionally homogeneous and permits the volume resistivity of a PVC compound to be 10 times greater than that from traditional compounding in an extruder, for the same content of carbon black.

Finally, the present invention is well suited to the manufacture of multimodal resins, i.e. mixtures of resins of the same type but of different properties (molecular weights, comonomer content, etc.). The following examples provide non-limiting illustration of the present invention.

### EXAMPLE 1 AND COMPARATIVE EXAMPLE 2

### Manufacture of Pigment Concentrates

### Example 1

### Compounding According to the Invention

200 g of compound based on SOLVIN S 271 SP PVC (K value 71) were introduced into 300 g of MEK at 75° C., with stirring (helical stirrer rotating at 250 rpm) in a jacketed reactor with useful capacity of about 5 litres. The formulation used is based on Ca/Zn stabilizers (1% by weight of Ca stearate and 0.5% by weight of Zn stearate) and on DOP (dioctyl phthalate-plasticizer-31% by weight).

16 g of Irgalite red 4BP pigment from CIBA-GEIGY (Ca monoazo salt) were added to the solution. The liquid was held at 75° C. with stirring (conditions same as above) for 1 hour.

After complete dissolution of the soluble chemical compounds, the stirring rate was increased to 1 000 rpm and 2.5 kg of steam were introduced during 40 minutes so as to evaporate the solvent and bring about the precipitation of the PVC compound. The solvent was recovered by condensation for reuse. The PVC compound product was in suspension in water. It was filtered on a 125 μm metal filter and then oven-dried in vacuo (0.2 bara) at 80° C. for 5 hours. The PVC compound powder precipitated was then screened on a 1 mm screen prior to use. Its particle sizes were the following: average diameter (d) 290 μm, 10% percentile: 218 μm and 90% percentile: 346 μm, 80% of the particles therefore having a diameter between d−0.24d and d+0.19d.

This product, used in a mixture with unpigmented compound so as to obtain a final pigment concentration of 0.05% by weight (i.e. utilizing one part of masterbatch for 160 parts of resin) gave good results for pigment dispersion during a test on a THORET extruder (single screw of diameter D 30 mm and length L such that L/D=20) conducted with a compression ratio of 2.5, a processing temperature of 160° C. and a throughput of 5 kg/h.

### Comparative Example 2

### Traditional Compounding

By the traditional compounding method (mixing, extrusion, pelletizing and micronizing) and staring from the same ingredients it was impossible to exceed a concentration of 5% of Irgalite red pigment, due to problems of deposits and of pigment agglomeration. For the THORET test it was therefore necessary to revert to 1 part of masterbatch for 99 parts of resin to obtain a result identical with that of Example 1.

### EXAMPLE 3

### Compounding According to the Invention and Traditional Compounding with Another Pigment

The test was the same as in Example 1, repeated with a content of 40% by weight of Irgalite yellow N6P pigment from CIBA-GEIGY (Ca monoazo salt) (i.e. 130 g of starting material for 200 g of PVC compound of formulation identical to that of Example 1).

The product obtained gave good results when used in a mixture with an unpigmented PVC compound in a THORET test to give a final pigment content of 0.05% (i.e. 1 part of masterbatch for 800 parts of resin).

By the traditional route it was impossible to obtain a compound with the same pigment content (poor quality of the product obtained in terms of dispersion and of pigment distribution when exceeding 25% by weight of pigment) and it was therefore necessary to use 1 part of masterbatch for 500 parts of resin to obtain an identical product in the THORET test.

### EXAMPLE 4 AND COMPARATIVE EXAMPLE 5

### Manufacture of Compounds for Primary Insulation

### Example 4

### Compounding According to the Invention

150 g of virgin PVC, K value 70,
60 g of DOP,
6 g of tribasic Pb sulphate,
65 g of CaCO₃,
2 g of Ca stearate,
4.2 g of carbon black,
10 g of Ca(OH)₂,
   were added with stirring (under conditions the same as in Example 1: helix rotating at 250 rpm) to 3 000 g of MEK at 75° C.

The liquid was held at this temperature with stirring (always under the same conditions) for 1 hour.

After complete dissolution of the soluble chemical compounds, the stirring was increased to 1 000 rpm, and 2.5 kg of steam were introduced during 40 minutes, so as to evaporate the solvent and bring about the precipitation of the PVC compound. The solvent was recovered by condensation for reuse. The PVC compound product was in suspension in water. It was filtered on a 125 μm metal filter and then oven-dried in vacuo (200 g) at 80° C. for 5 hours. The PVC compound powder precipitated was then screened on a 1 mm screen prior to use.

### Comparative Example 5

### “Traditional” Compounding

150 g of virgin PVC, K value 70,
60 g of DOP,
6 g of tribasic Pb sulphate,
65 g of CaCO₃,
2 g of Ca stearate,
4.2 g of carbon black,
10 g of Ca(OH)₂,
   were introduced into a jacketed high-speed mixer.

The mixing of the additives and PVC was conducted at high speed (1 500 rpm) with monitoring of the temperature rises of the powder. When the temperature of the powder reached 115° C., the mixer was turned down to low speed (750 rpm) and the jacket cooling was switched on. When the temperature of the powder reached 30° C., the stirring was stopped and the product was transferred into an open kneader whose cylinders were controlled to a temperature of 170° C. The rotation rate of the cylinders was held at 30 rpm and the friction rate used was 1.1.

Once a homogeneous mixture was obtained, the chronometer was switched on and the product was again kneaded for 5 minutes, during which the material was regularly peeled away from the cylinder to ensure good homogenization.

The resultant product was cooled to ambient temperature with the aid of metal plates and was then diced to give pellets whose dimensions were a few millimetres.

Production of Test Specimens

To evaluate the dielectric properties of the products obtained in Examples 4 and 5 (comparative), these were pressed in the form of plaques of thickness 2 mm by the following procedure:
heating the material to 180° C. for a period of 3 minutes while simply maintaining contact with the mould,
operating at higher pressure (15 bar) during a period of 3 minutes (the pressure level being controlled as a function of the flow of the product and being reduced to 7 bar if necessary),
cooling for a period of 6 minutes.
   Dielectric Properties of the Resultant Compounds

Volume resistivity was measured on the plaques produced as above in accordance with the CENELEC HD21 (11-1997) standard.

Before the specimens were prepared, they were degreased with petroleum ether.

The electrodes consisted of aluminium sheets and the adhesive was vaseline.

The test was carried out using a voltage of 100 volts at 24° C.

The results obtained are:

| | |
|---|---|
| PVC compound according to the invention | 2 100 Mohm · km |
| Compound obtained by traditional route | 240 Mohm · km |

1. A process for manufacturing a mixture which comprises a plastic and at least one additive, the process comprising:
1.) dissolving the plastic in a solvent to form a solution, wherein the plastic is in the form of powder or of pellets;
2.) introducing the additive(s) into the solution after or during the dissolution;
3.) injecting a non-solvent into the solution to precipitate the plastic in solution, wherein
the solvent and the non-solvent are miscible and form an azeotrope;
the non-solvent is injected in both liquid and gaseous form; and
much of the solvent is removed from the precipitation medium by evaporation in the form of azeotropic vapour.

2. The process according to claim 1, wherein the plastic is polyvinyl chloride.

3. The process according to claim 1, wherein the plastic is dissolved in the presence of a phase-separator compatible with the solvent and incompatible with the non-solvent.

4. The process according to claim 1, wherein the solubility parameter of the solvent is similar to the solubility parameter of the plastic and the solubility parameter of the phase-separator is:
lower than the solubility parameter of the plastic if the solubility parameter of the non-solvent is higher than the solubility parameter of the plastic, or
higher than the solubility parameter of the plastic if the solubility parameter of the non-solvent is lower than the solubility parameter of the plastic.

5. The process according to claim 1, wherein the precipitation takes place in the presence of a dispersing agent.

6. The process according to claim 1, wherein the non-solvent is progressively injected into the solvent comprising the dissolved plastic and the pressure is progressively reduced below atmospheric pressure during the injection of the non-solvent.

7. The process according to claim 1, wherein
the plastic comprises catalytic residues and
the plastic in solution is treated with a reactant capable of neutralizing said catalytic residues.

8. A mixture prepared by the process according to claim 1, wherein the mixture has of substantially spherical particles having an average diameter (d) between 100 and 800 μm and a breadth of distribution such that at least 80% of the particles have a diameter between d−0.4d and d+0.4d.

9. The process according to claim 1, wherein said mixture is at least one pigment concentrate, at least one compound for primary insulation or at least one multimodal resin.

10. A composition comprising at least one pigment concentrate, at least one compound for primary insulation or at least one multimodal resin which comprises the mixture as prepared by the process as claimed in claim 1.
